(19) United States
(12) Patent Application Publication
(10) Pub. No.: US 2003/0175561 A1
(43) Pub. Date: Sep. 18, 2003

(54) Production of electricity from fuel cells achieved by biomass gasification

(76) Inventor: Gene E. Lightner, Federal Way, WA (US)

Correspondence Address: Gene E. Lightner, 706 S.W., 296th St., Federal Way, WA, 98023-3549, US

(21) Appl. No.: 10/100,349

(22) Filed: Mar. 18, 2002

(51) Int. Cl. H01M 8/06

(52) U.S. Cl. 429/17; 429/16; 429/30; 429/9

(57) ABSTRACT

This method will produce electricity from fuel cells achieved by gasification of a biomass. Biomass is subjected to steam for gasification of a biomass and produce a gas containing hydrogen, carbon monoxide, and organic compounds subject to reforming. Resultant gas is used to power fuel cells to generate electricity and create waste heat. Exothermic heat from the fuel cell reaction is transported by thermal conduction to provide energy for gasification of a biomass contained in a vessel. Waste heat is employed to vaporize water to produce steam to be employed for gasification of a biomass, whereby gasification of aa biomass provides energy to fuel cells to generate electricity.

### BACKGROUND OF THE INVENTION

Fuel cells are used to generate electricity, commonly from a hydrocarbon fuel. An external reformer, employing steam and a catalyst, transform the hydrocarbon to produce a gas containing hydrogen and carbon monoxide. This gas is subjected to steam and a catalyst to shift the carbon monoxide to hydrogen and carbon dioxide. Upon removing traces of carbon monoxide and carbon dioxide, the gas containing hydrogen is employed to power fuel cells. State of the art fuel cells operating at a temperature from about 600° C. to about 1,000° C. are designated as molten carbonate (MCFC) and solid oxide (SOFC) fuel cells. These fuel cells reform carbohydrates to form hydrogen and carbon monoxide and generate internal exothermic heat. These fuel cells also, using water vapor convert carbon monoxide to carbon dioxide and hydrogen. Accordingly the fuel cells are absent of carbon monoxide poisoning.

State of the art biomass gasification employs a fixed bed or a fluidized bed to react steam with a biomass to from a gas containing hydrogen, carbon monoxide and organic compounds subject to reforming and steam splitting to form a gas containing hydrogen and carbon dioxide. The resulting gas is subject to reforming and steam splitting by MCFC or SOFC fuel cells

Therefore, an object of this invention is to obviate many of the limitations and disadvantages of the prior art

This invention relates to gasification of a biomass to supply gas to fuel cells.

An important object of this invention is to apply gasification of a biomass to reforming and steam splitting by MCFC or SOFC fuel cells.

A secondary object of this invention is to employ MCFC or SOFC fuel cells to generate electricity from gasification of a biomass.

Furthermore, an object of this invention is to utilize internally generated exothermic heat which is transmitted to a biomass for gasification.

An additional object of this invention is to employ waste heat from the fuel cells to form steam.

With the above and other objects in view, this invention relates to the novel features and alternatives and combinations presently described in the brief description of the invention.

### PHRASEOLOGY APPLIED IN THE INVENTION

This invention relates to a biomass wherein the biomass is selected from the group consisting of wood, paper, and lignocellulose materials including an individual or a combination thereof.

Biomass for gasification is contained in a vessel containing a catalyst for steam forming the biomass to form a gas containing hydrogen, carbon monoxide and organic compounds subject to reforming and steam splitting to form a gas containing hydrogen and carbon dioxide. Biomass gasification is the subject related by “HyWeb: Knowledge-Hydrogen in the Energy Sector” Chapter 3, pages 3 and 4. Also obtained on the internet, March, 2002, is “Conversion Routes, General Information” under the heading “Gasification” in which attainment with a fluidized bed or a fixed bed is used for gasification of biomass. Biomass, confined within a vessel containing a catalyst, reacts with steam supplied to the vessel to accomplish biomass gasification.

Reforming and steam splitting are functions actualized within fuel cells selected from the group consisting of molten carbonate fuel cells, solid oxide fuel cells or a combination thereof. Obtained on the internet, “Fuel Cell Handbook”, Fourth Edition, November 1998, section 1, part 1, pages 4-6, is a list of fuel cells, and a summary of major differences of the fuel cell types. Selected fuel cell type upon reaction, at high temperature, with hydrogen, organic compounds and carbon monoxide, contained within a gas and oxygen from air, generates internal exothermic heat and forms waste heat. The resulting exothermic heat is transmitted, as required, to the biomass vessel by conduction. Waste heat is used to evaporate water and form steam to be supplied to the biomass vessel. Accordingly heat is transmitted to the biomass gasification vessel. The net result is generation of electricity by the fuel cells relying on gas from biomass gasification

### BRIEF DESCRIPTION OF THE INVENTION

The present invention, in its broadest aspect, is a method to generate electricity from fuel cells powered by gasification of a biomass, which comprises: providing fuel cells, a biomass, and water vapor. Exothermic heat, generated within the fuel cells, is transmitted by thermal conduction to the vessel used for biomass gasification. Upon combining water vapor with biomass, gasification forms a gas containing hydrogen, carbon monoxide and organic compounds subject to reforming. The gasification of biomass is, upon subjecting the gas derived from a biomass to air, to react within the fuel cells to generate electricity and create waste heat. Upon creating water vapor from evaporation of water, utilizing waste heat, steam is created for transfer to the biomass gasification vessel.

Key features of this invention are:

Biomass for gasification is contained within a vessel.

Gas, produced from a biomass for gasification is used to power fuel cells.

Exothermic heat is generated within powered fuel cells.

Heat from fuel cells is transmitted by conduction to the gasification from biomass vessel

The fuel cells are stacked in layers enclosed by metal layers for conduction of exothermic heat generated within the fuel cells

Biomass is commonly reduced in size to about one fourth inch in size.

Gasification of a biomass is with steam generated by fuel cells.

Fuel cells powered by gasification from a biomass will generate electricity.

Waste heat, generated by fuel cells, is employed to vaporize water to form superheated steam.

Fuel cells generate direct current which is occasionally converted to alternating current.

Fuel cells generate direct current which is sometimes suitably stored within a storage battery.

### BRIEF DESCRIPTION OF THE DRAWING

The features that are considered characteristic of this invention are set forth in the appended claims. This invention, however, both as to its origination and method of operations as well as additional advantages will best be understood from the following description when read in conjunction with the accompanying drawing in which:

FIG. 1 is a flow sheet denoting the invention as set forth in the appended claims.

### DETAILED DESCRIPTION OF THE PREFERRED EMBODIMENT

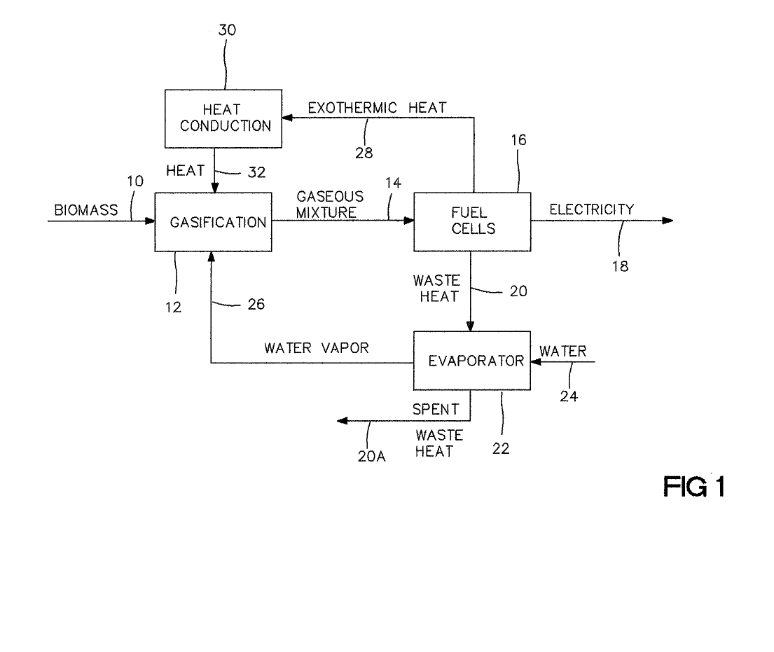

In the preferred embodiments of the present invention, gases from gasification of a biomass is forwarded to fuel cells to generate electricity. Fuel cells are operated at an established predetermined temperature from about 600° C. to about 1,000° C. The flow diagram of FIG. 1 illustrates the general preferred embodiments of the present invention. In the diagram, rectangles represent stages or functions of the present invention and not necessarily separate components. Arrows indicate direction of flow in the method.

Referring to FIG. 1, a biomass 10, is conveyed into gasification stage 12, which forms gaseous mixture 14, and is forwarded to fuel cells 16 to generate electricity 18 and exothermic heat 28. Exothermic heat 28 is transferred by heat conduction stage 30. to transfer heat 32 to gasification stage 12. Waste heat 20 from fuel cells 16 is forwarded to evaporation stage 22 to evaporate water 24 supplied to evaporation stage 22 to transfer energy and form spent waste heat 20A and generate water vapor 26 to gasification stage 12, to form gaseous mixture 14. Fuel cells 16 are operated at an established, predetermined temperature of about 600° C. to about 1,000° C., are devoid of platinum catalysts, and convert water and carbon monoxide within gaseous mixture 14 to form hydrogen and carbon dioxide. Exothermic heat generated within fuel cells transports heat by thermal conduction, commonly using a metal, to gasification stage 12, to provide heat required for gasification. Gaseous mixture 14, contains organic compounds subject to reformation within fuel cells 16, as well as conversion of carbon monoxide to hydrogen and carbon dioxide. Electricity 18, is often stored within a storage battery for subsequent withdrawal of electricity.

What is claimed is:

1. A method to produce electricity from fuel cells relying on gasification of a biomass for power, which comprises:
providing fuel cells, and
providing a biomass, and
providing water vapor, and
combining said water vapor with said biomass for gasification of said biomass to form a gaseous mixture containing organic compounds subject to reforming, hydrogen and carbon monoxide, and
subjecting said gaseous mixture and air to said fuel cells to generate said electricity and exothermic heat and create waste heat, and
creating said water vapor from water using said waste heat for energy whereby gasification from a biomass provides energy to fuel cells to generate electricity.

2. The method as described in claim 1 wherein said fuel cells are selected from the group consisting of molten carbonate fuel cells, solid oxide fuel cells or a combination thereof.

3. The method as described in claim 1 wherein said biomass is selected from the group consisting of wood, paper, and lignocellulose materials including an individual or a combination thereof.

4. The method of claim 1 wherein said fuel cells are established at a predetermined temperature of about 600° C. to about 1,000° C.

5. The method of claim 1 wherein said biomass is contained within a vessel containing a catalyst.

6. The method of claim 5 wherein the vessel containing a catalyst is established at a predetermined temperature of about 600° C. to about 1,000° C.

7. The method of claim 6 wherein the vessel containing a catalyst is maintained at a predetermined temperature of about 600° C. to about 1,000° C. by exothermic heat generated from said fuel cells.

8. The method of claim 6 wherein the vessel containing a catalyst is maintained at a predetermined temperature of about 600° C. to about 1,000° C. by heat generated by electricity.

9. The method of claim 1 wherein said fuel cells generate direct current.

10. The method of claim 8 wherein the direct current is converted to alternating current.

11. The method of claim 1 wherein said biomass is of about one fourth inch in size.

12. The method of claim 1 wherein said water vapor is superheated steam.

13. The method of claim 1 wherein said fuel cells are operated at a predetermined temperature from about 600° C. to about 1,000° C.

14. The method of claim 1 wherein said fuel cells waste heat substantially forms steam.

15. The method of claim 1 wherein said fuel cells, generating exothermic heat, transports heat by thermal conduction to said biomass within a vessel containing a catalyst.

16. The method of claim 15 wherein the fuel cells transport exothermic heat by a metal.

17. The method of claim 1 wherein said fuel cells are stacked in layers enclosed by metal layers.

18. The method of claim 1 wherein said fuel cells are devoid of platinum catalysts.

19. The method of claim 1 wherein said fuel cells generate electricity which is often stored within a storage battery.
